(19) United States
(12) Patent Application Publication
(10) Pub. No.: US 2011/0277943 A1
(43) Pub. Date: Nov. 17, 2011

(54) Window Covering

(75) Inventor: Tzong-Fu Lin, Taipei (TW)

(73) Assignee: Whole Space Industries LTD, Taipei (TW)

(21) Appl. No.: 12/780,245

(22) Filed: May 14, 2010

(51) Int. Cl. E06B 9/60; E06B 9/24; E06B 9/303; A47G 5/02

(52) U.S. Cl. 160/84.04; 160/241; 160/170; 160/84.01

(57) ABSTRACT

A window covering includes at least one spring motor attached to a rotatable shaft. The spring motor includes at least one spring member that has an elongated body having a windable length, a uniform thickness throughout the windable length, a uniform width throughout the windable length, and a uniform rectangular cross section throughout the windable length. The spring member is configured so that it has a different microstructure at different portions of the first spring member located along the windable length of such that the spring member exerts an amount of force as the portions of the first spring member may wind about a roller of the spring motor that progressively increases such that the roller may prevent movement of the shaft to maintain a position of the window covering material after the window covering material is moved to a particular raised position.

### FIELD OF INVENTION

The present invention relates to window coverings such as cordless shades, venetian blinds, cellular shades and other shades and blinds.

### BACKGROUND OF THE INVENTION

Cordless blinds typically have cords that run between a headrail and a bottom rail and are collected on spools or axles in the headrail or bottom rail. Such shades are often referred to as “cordless” because an operator cord is not used for the raising or lowering of the shade material. Instead, spring motors or electric motors are provided to turn the spools or axles on which the cords are collected. A user may adjust the position of the shade material by lifting the shade material up or by pulling the shade material down without the use of any operator cord extending from a cord lock. Examples of cordless shades in which the cords are wound on spools connected to spring motors can be found in the patents of Otto Kuhar and Ren Judkins. For example, Kuhar discloses a balanced cordless window covering in U.S. Pat. No. 6,474,394. Judkins discloses a cordless blind which utilizes a constant force spring motor and lock mechanism in U.S. Pat. No. 6,644,372. Other examples of cordless shades may be appreciated from U.S. Pat. Nos. 13,251, 2,390,826, 5,531,257, 5,813,447, 6,330,899, 6,684,930, 6,837,294, 6,991,020 and U.S. Patent Application Publication Nos. 2004/0154758, 2005/0109471, 2007/0039696, 2007/0023151, 2007/0163727, 2008/0295975, 2008/0128097, and 2009/0301670.

Cheng et al. disclose a cordless blind that has a secondary cord that is tied to primary lift cords and extends to a spring motor. See U.S. Pat. Nos. 6,991,020 and 6,837,294 to Cheng et al. and U.S. Patent Publication No. 2004/0154758 to Cheng et al. The spring motor balances and holds the window covering material after it is raised or lowered by a user.

The connection of primary and secondary cords requires a substantial length of cord between the connection point and rollers within the headrail to avoid the risk of entangling the connection point with the rollers. Thus, the blinds disclosed by Cheng et al. require the primary cords to extend a substantial length between a roller and the secondary cord to ensure that no portion of the secondary cord extends to a roller when the blind is lowered. Such a length requires very long headrails.

Further, the headrails for such blinds are often configured to have numerous rollers positioned throughout the length of the headrail to engage the primary cords and ensure the primary cords have the required length between the secondary cord and rollers. The use of these extra rollers increases the cost of the window covering. The headrail that houses the extra rollers may also be required to be taller to accommodate the multiple cord paths and rollers. Many users prefer a narrow headrail that is less noticeable. However, a narrow headrail cannot be used with the mechanism disclosed by Cheng et al.

The use of multiple rollers in the cord path also creates more friction in the system as compared to a cord path with no rollers. The increased friction requires that a stronger spring motor or more powerful electric motor be used, which can increase the cost of the window covering.

Typically, cordless shades utilize a spring motor that provides a constant force spring for maintaining the position of window covering material. The torque provided by such springs often results in providing too much force so that when the shade is fully lowered, the shade material may “creep” upwards instead of staying in the lowered or extended position. Toti discloses the use of intermeshed gears or transmission mechanisms used for interconnecting spring motors in U.S. Pat. No. 6,957,863 in an attempt to translate the torque provided by one or more spring motors to reduce the likelihood of such “creep” occurring. However, such transmission systems are often expensive and can add a significant amount of cost to the manufacture of cordless shades.

Alternatively, brakes have been used to maintain a position of window covering material in a lowered position. For instance, U.S. Pat. No. 6,684,930 discloses a brake used in cordless shades. The brake is configured to releasably engage lift cords so that the brake must be disengaged before the window covering material may be repositioned. The disengaging of the brake typically requires a user to manipulate the window covering material to release the brake. For example, a user may have to pull the window covering material downward to release the brake before raising the position of the window covering material. A user may also have to manipulate the window covering material to reengage the brake.

Brake mechanisms often add cost to a cordless shade as it is another element that must be included in cordless shades. Further, users may have difficulty getting a brake to disengage when trying to reposition window covering material. Users may also have difficulty manipulating the shade sufficiently for the brake to reengage. Such difficulties can lead a consumer to believe that his or her cordless shade is not working properly or is damaged.

U.S. Pat. No. 6,474,394 to Kuhar discloses the use of spring motors that use springs that have a varying amount of force based on the geometry of the spring element of the spring motor. The springs disclosed by Kuhar vary the force provided by the springs by tapering the width of the spring element used in the spring motor or by varying the thickness of the spring element. Such geometric changes to the spring element require the use of drums that have sidewalls configured to receive and hold such elements. Without the use of such specially configured drums, the springs may not reliably wind and unwind from the drums. For instance, a portion of the spring element may become positioned outside of the sidewalls during operation of a shade, which may prevent the shade from working properly until the shade is fixed. The use of such drums may also add cost to the manufacture of spring motors because typically configured pulleys that are less costly and available from a large number of suppliers are not typically used for such spring motors.

A new cordless shade design is needed that permits a cordless shade to be manufactured at a lower cost while also offering greater reliability. Preferably, such a cordless shade would permit a user to easily and reliably adjust the position of the shade material when raising or lowering the shade. Such a cordless shade would preferably not need to include any transmission or intermeshed gear mechanisms for varying the amount of torque provided by a spring motor, nor a brake mechanism for maintaining a position of the window covering material for such a shade.

### SUMMARY OF THE INVENTION

A window covering is provided that includes a first rail, window covering material positioned adjacent to the first rail that is moveable from a retracted position to an extended position, and a control mechanism for maintaining a position of the window covering material at a user selected position. The control mechanism includes a rotatable shaft positioned adjacent to the first rail. The rotatable shaft has a first end and a second end opposite the first end. The rotatable shaft is rotatable in a first direction and a second direction opposite the first direction. The window covering material is attached to the rotatable shaft such that the window covering material extends when the rotatable shaft rotates in the first direction and retracts when the rotatable shaft rotates in the second direction.

The window covering also includes a first spring motor attached to the first rail. The first spring motor includes a first roller, a second roller and a first spring member that extends from the first roller to the second roller. A portion of the rotatable shaft adjacent to the first end of the rotatable shaft is attached to the second roller so that rotation of the second roller in the second direction causes the rotatable shaft to rotate in the second direction and rotation of the rotatable shaft in the first direction causes the second roller to rotate in the first direction. The first spring member is moveable from the first roller to the second roller such that the first spring member is windable about the second roller when the second roller rotates in the second direction and the first spring member is windable about the first roller when the second roller rotates in the first direction. The first spring member has an elongated body that has a generally rectangular shape. The body has a windable length, a uniform thickness, a uniform width and a uniform rectangular cross section throughout the windable length of the first spring member.

The first spring member is configured so that the first spring member has a different microstructure at different portions of the first spring member located along the windable length of the first spring member such that the first spring member exerts an amount of force as the portions of the first spring member wind about the second roller that progressively increases such that the second roller prevents movement of the rotatable shaft to maintain a position of the window covering material after the window covering material is moved to the retracted position and exerts a progressively lesser amount of force as the portions of the first spring member wind about the first roller such that the second roller prevents movement of the rotatable shaft to maintain a position of the window covering material after the window covering material is moved to the extended position.

Embodiments of the window covering may also include one or more lift cords that extend from a position adjacent to the rotatable shaft to the window covering material to attach the window covering material to the shaft such that the window covering material extends when the shaft rotates in the first direction and retracts when the shaft rotates in the second direction. The one or more lift cords may include only one lift cord or may include two or more lift cords. A plurality of pulleys may be attached to the shaft so that each pulley is attached to a respective lift cord to attach that lift cord to the rotatable shaft. Rotation of the shaft can cause the pulleys to move to cause the lift cords to wind about or unwind from the pulleys for extending and retracting the window covering material. One or more bushings members may also be provided to attach to the pulleys. The bushing members may be sized and configured to provide an interference connection between the rotatable shaft and the pulleys.

Preferably, the first spring member is composed of steel, such as a stainless steel, type 301 steel, or another type of steel. The strength of the first spring member may vary at different portions along the length of the spring member. The varied strength may be formed via a heat treatment process applied during the manufacturing of the steel of the first spring member.

In some embodiments of the window covering, the first spring motor may include a third roller, a fourth roller and a second spring member that extends between the third roller and the fourth roller. The fourth roller may be attached to the second roller so that rotation of the fourth roller in the second direction helps because the rotatable shaft to rotate in the second direction and rotation of the rotatable shaft in the first direction causes the fourth roller to rotate in the first direction. The second spring member is moveable from the third roller to the fourth roller so that the second spring member is windable about the fourth roller when the fourth roller rotates in the second direction and is windable about the third roller when the fourth roller rotates in the first direction. The second spring member has an elongated body that has a generally rectangular shape. The body has a windable length, a uniform thickness, a uniform width and a uniform rectangular cross section throughout the windable length of the second spring member.

The second spring member is configured so that the second spring member has a different microstructure at different portions of the second spring member located along the windable length of the second spring member such that the second spring member exerts an amount of force as the portions of the second spring member wind about the fourth roller that progressively increases such that the fourth roller helps prevent movement of the rotatable shaft to maintain a position of the window covering material after the window covering material is moved to the retracted position and exerts a progressively lesser amount of force as the portions of the second spring member wind about the third roller such that the fourth roller prevents movement of the rotatable shaft to maintain a position of the window covering material after the window covering material is moved to the extended position.

Other embodiments of the window covering include a second spring motor attached to the second end of the rotatable shaft. The second spring member may include first and second rollers and a first spring member attached between the first and second rollers. Some embodiments of the second spring motor may also include a third roller, fourth roller and second spring member attached between the third and fourth rollers. It should be appreciated that the second spring motor's rollers and spring members may be sized and configured to function similarly to the components of the first spring motor.

For some embodiments of the window covering, the first direction may be clockwise and the second direction may be counter clockwise. In other embodiments, the first direction may be counter clockwise and the second direction may be clockwise.

Preferably, the window covering is configured so that no transmission mechanism or gear mechanism is utilized to convert torque provided by the first spring member of the first spring motor. If additional spring member or spring motors are used, preferably no transmission mechanism or gear mechanism for converting torque provided by those spring motors are used either. The non-use of such transmission mechanisms or gear mechanisms may help reduce the cost of manufacturing the window covering.

Embodiments of the window covering are preferably a cordless shade that includes a headrail as the first rail. The window covering may be comprised of cellular material, slats on rope ladders, pleated material, fabric material, non-woven material, woven wood material, woven grass material, bamboo, or interconnected fabric segments. The window covering material may also be a film or other material for covering a window opening. Embodiments of the window covering may also include a bottom rail attached to at least one of the window covering material and at least one lift cord.

The rotatable shaft may have a number of different shapes or sizes. Preferably, the rotatable shaft has a cross section that has a polygonal shape or is a rod or bar.

Embodiments of the window covering may include one or more bushings to attach an end of the shaft to the second roller of the first spring motor. For instance, the second roller may have an opening and an end of the shaft may be within that opening. The one or more bushings may be within that opening to provide an interference attachment between the second roller and the shaft.

The spring members used in the one or more spring motors may include a body that has plurality of integrally attached portions. For instance, an elongated body of a spring member may have a first portion, a second portion and a third portion. The first and third portions may be adjacent to opposite ends of the spring member and the second portion may be between the first and third portions. Each portion may have a different microstructure and a different strength.

Other details, objects, and advantages of the invention will become apparent as the following description of certain present preferred embodiments thereof and certain present preferred methods of practicing the same proceeds.

### BRIEF DESCRIPTION OF THE FIGURES

Present preferred embodiments of my window covering are shown in the accompanying drawings and certain present preferred methods of practicing the same are also illustrated therein.

FIG. 1 is an exploded view of a first present preferred embodiment of my window covering.

FIG. 2 a front view of the first present preferred embodiment of my window covering with the window covering material in a raised, or retracted, position.

FIG. 3 is a front view of the first present preferred embodiment of my window covering with the window covering material in a lowered position, or extended, position.

FIG. 4 is a perspective view of a present preferred spring member that may be used in embodiments of my window covering.

FIG. 5 is a perspective view of the present preferred spring member that may be used in embodiments of my window covering in a straight configuration to illustrate the uniform width and thickness of the spring member.

FIG. 6 is a graph illustrating the load applied by a present preferred spring member when window covering material is extended.

FIG. 7 is a graph illustrating how a constant force spring member having a constant or uniform toughness throughout the spring member applies load when window covering material is extended.

FIG. 8 is an exploded view of a second present preferred embodiment of my window covering.

### DESCRIPTION OF PRESENT PREFERRED EMBODIMENTS

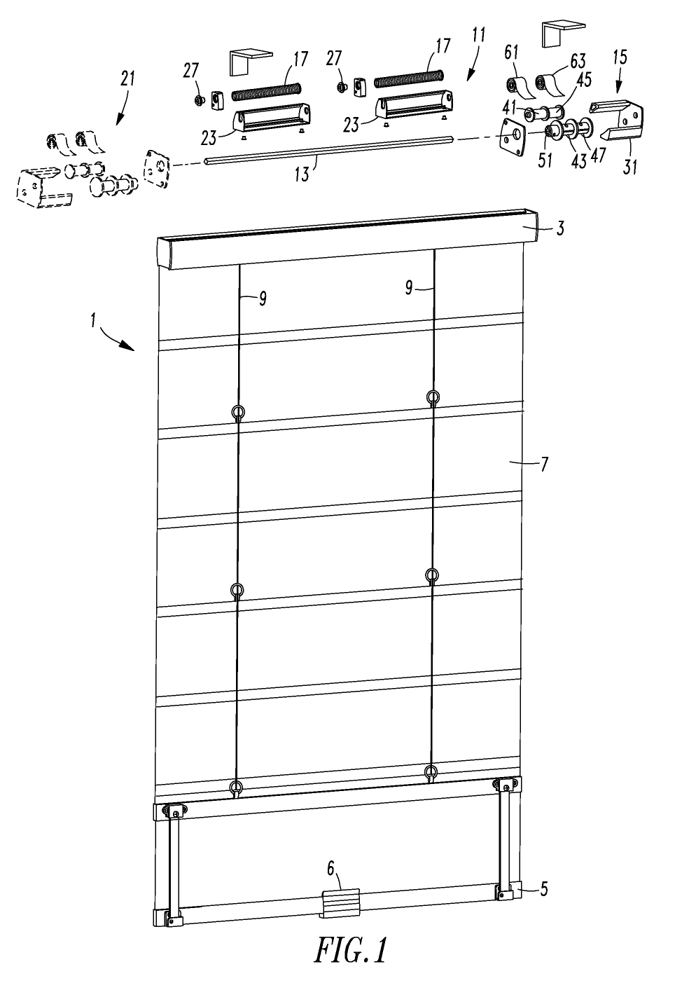

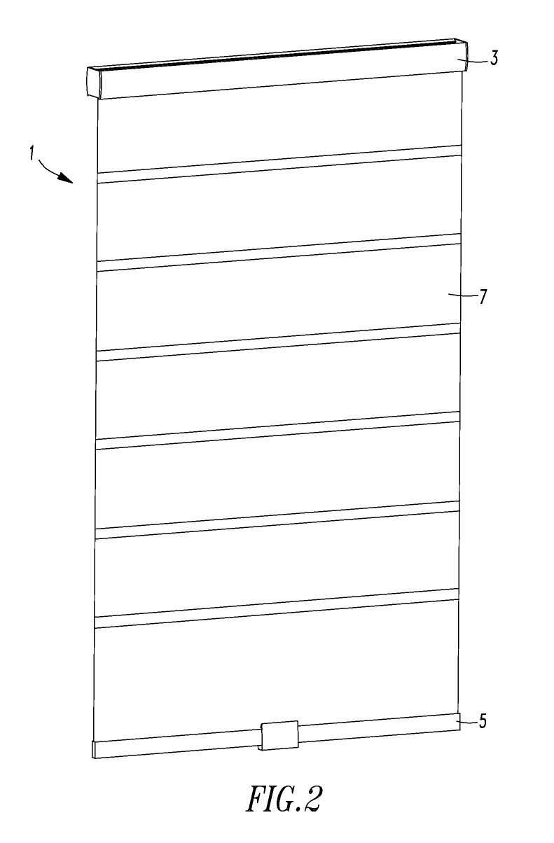

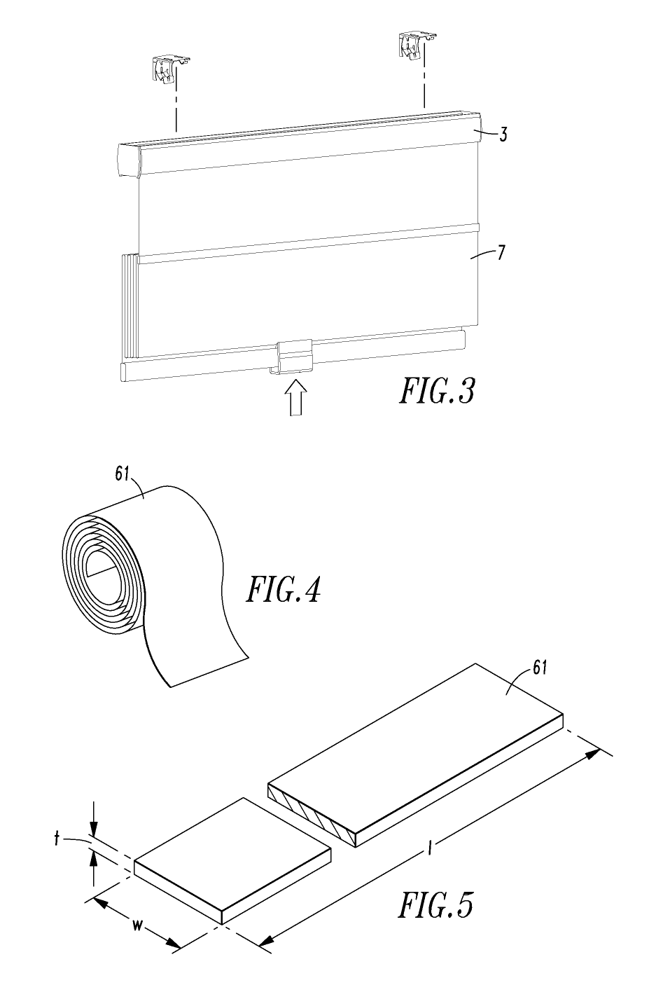

Referring to FIGS. 1-5, a first present preferred embodiment of my cordless window covering 1 has a headrail 3, a bottom rail 5 and window covering material 7 between the headrail and the bottom rail. The headrail may be an extruded rail composed of plastic or metal or may be composed of wood or other materials. The bottom rail may be formed from plastic, metal, wood, or other materials as well.

The window covering material 7 is moveable from a raised position, or retracted position, to a lowered position, or an extended position. When in the extended position, the bottom of the window covering material and the bottom rail are farther from the headrail than when the window covering material is in the raised, or retracted position. A handle 6 may be attached to the bottom rail 5 to help users move the window covering material to a desired position.

The window covering 1 is configured so that a user may use the handle 6 and pull down to adjust the position of the window covering material 7 to a lower position. When the user stops providing a downward force, the window covering material will remain in that position due to a control mechanism within the headrail 3, which is discussed more fully below. When a user wishes to raise the window covering material, a user may push up on the handle. The application of an upward force on the window covering material will actuate the control mechanism and cause the window covering material to retract towards the headrail 3. When a desired position is reached, the user may stop applying an upward force to the handle and the window covering material will stop moving. The control mechanism in the headrail 3 will then maintain the position of the window covering material until the user applies a force to the window covering material to change the position of the window covering material. It should be understood that the window covering 1 is a cordless window covering because it does not require a user to manipulate any cord to adjust the position of the window covering material.

It is contemplated that a rod or other device may be attached to the window covering to help a user adjust the position of the window covering. For instance, for window coverings that may be very high above the ground when mounted, a rod or pole or other tool may be attached to the window covering material or bottom rail of the window covering that is accessible to a user for manipulating to adjust the position of the window covering material.

A control mechanism that may be utilized in embodiments of my window covering for permitting a user to adjust the position of the window covering material will now be discussed in more detail. The window covering 1 includes lift cords 9 and a lift cord control mechanism 11. The lift cords extend from the headrail 3 to a lower portion of the window covering material 7. For instance, the lift cords 9 may pass through the window covering material or may pass through rings attached to the window covering material. The lift cords 9 may each have a terminal end attached to a bottom portion of the window covering material 7 or may be attached to the bottom rail 5.

The lift cord control mechanism 11 is positioned in the headrail 3 and includes a rotatable shaft 13 attached to at least one spring motor. A first spring motor 15 may be attached to a first end of the rotatable shaft 13. Depending on the size and weight of the window covering material, a second spring motor 21, which is shown in dotted line in FIG. 1, may also be attached to the other end of the rotatable shaft opposite the first end. As an alternative, it is contemplated that one or more spring motors may be attached to mid portions of the shaft 13. Such positions may be adjacent to an end of the shaft 13. Of course, if more than two spring motors were needed, spring motors could be attached at both ends of the shaft 13 and at other positions between the ends of the shaft 13 as well.

The lift cords 9 are collected on pulleys 17 attached to the rotatable shaft 13. The pulleys 17 are attached to the shaft 13 so that the pulleys rotate when the shaft 13 rotates. The pulleys 17 may be attached to the shaft so that the pulleys slide along the shaft as the shaft and pulleys rotate. As an alternative, the pulleys 17 may be affixed to the shaft so that the rollers stay in a particular position and rotate when the shaft rotates. The pulleys 17 may be positioned within carriages 23. The pulleys may have a channel 25 sized and configured to receive the shaft for attachment to the shaft 13. One or more bushings 27 may also be attached to each pulley to provide an interference fit between the pulley 17 and the shaft 13. At least a portion of each bushing 27 may extend within the channel 25 of the pulley to which it is attached or may be attached adjacent to an end of the pulley and include an opening sized to receive a portion of the shaft to affix the pulley 17 to the shaft 13.

The rotatable shaft rotates in a first direction and a second direction that is opposite the first direction. When the rotatable shaft rotates in the first direction, the lift cords are unwound from the pulleys 17 so that the window covering material 7 extends. When the rotatable shaft rotates in the second direction, the pulleys 17 move to wind up, or collect the lift cords 9 to retract the window covering material, or raise the window covering material.

The first spring motor 15 includes a housing 31 that is attached within the headrail 3. The housing is attached to a first roller 41, a second roller 43, a third roller 45 and a fourth roller 47. The rollers are all rotatable in the first direction and in the second direction. The first and third rollers 41 and 45 may be portions of a double roller and the second 43 and fourth 47 rollers may be portions of a double roller. The second roller 43 may also include an opening 51 that is sized and configured to receive the first end of the shaft 13 to attach the shaft 13 to the second roller 43. It is contemplated that a bushing (not shown) may also be attached between the shaft 13 and the second roller 43 to provide a tight interference attachment between the shaft 13 and second roller 43. The opening 51 may alternatively be within another structure attached to the second roller for attaching the shaft 13 to the second roller 43. It should be appreciated that alternative embodiments of my window covering may include a spring motor that has the rotatable shaft attached to the first roller 41 instead of the second roller 43.

A first spring member 61 is attached between the first roller 41 and the second roller 43. Opposite ends of the spring member may be attached to the first roller 41 and second roller 43, respectively. The first spring member 41 is preferably composed of type 301 stainless steel, or grade 301 stainless steel, and is preferably obtained from Vulcan Spring and Manufacturing Co., which has a place of business located at 501 Schoolhouse Road, Telford, Pa. 18969 USA. The type 301 stainless steel has a negative gradient so that the strength of the steel is different at different locations along the length of the first spring member 61. Such a variation in strength may be provided by heat treating the steel so that the microstructure of the spring member is different at different locations along the length of the spring member 61 so the strength of different portions of the spring member 61 along the length of the spring member are different. It should be understood the appearance of such a microstructure may be different for different types of steels that may be used in spring members.

As may be appreciated from FIGS. 4 and 5, the first spring member 61 has an elongated body that has a length 1. The length 1 should be sufficiently long enough to permit the spring member to wind about a roller of the spring motor during lowering and raising of the window covering material from a fully raised position to a fully lowered position. The body of the first spring member 61 is preferably generally rectangular in shape and has a uniform width w and thickness t. The cross section of the spring member 61 is rectangular. The rectangular cross section is uniform throughout the length 1 of the spring member 61.

It is also contemplated that the end portions of the spring member may be sized and shaped differently for attachment to different rollers of a spring motor. Though the end portions may be polygonal shaped or rounded for attachment to the rollers, it should be understood that such a spring member is still considered generally rectangular in shape if the windable length of the spring member is rectangular in shape or generally rectangular in shape. For such embodiments, the windable length of the spring member is preferably generally rectangular in shape and has a uniform width and thickness along the windable length of the spring member. It should be appreciated that the windable length is a length of the spring member that is configured to wind about different rollers of a spring motor. The cross section of the spring member along its windable length is also preferably rectangular and is uniform throughout the windable length of the spring member.

A portion of the first spring member 61 is moveable from the first roller 41 to the second roller 43 such that the portion of the first spring member 61 is windable about the second roller 43 when the second roller rotates in the second direction. The first spring member is windable about the first roller 41 when the second roller rotates in the first direction.

The first spring member is configured so that the first spring member has a different toughness at different portions of the spring member located along the length of the first spring member such that the first spring member exerts an amount of force as the portion of the first spring member winds about the second roller that progressively increases such that the second roller can prevent movement of the rotatable shaft to maintain a position of the window covering material after the window covering material is moved to the retracted position. The first spring member is also configured to exert a progressively lesser amount of force as the portion of the first spring member winds about the first roller such that the second roller can prevent movement of the rotatable shaft to maintain a position of the window covering material after the window covering material is moved to the extended position.

The second spring member 63 is preferably the same material as the first spring member 61 and has the same shape and configuration as the first spring member 61. Opposite ends of the second spring member 63 are attached to the third roller 45 and the fourth roller 47, respectively. A portion of the second spring member 63 is moveable from the third roller 45 to the fourth roller 47 such that the portion of the second spring member 63 is windable about the fourth roller 47 when the second roller 43 rotates in the second direction. The second spring member 63 is windable about the third roller 45 when the fourth roller 47 rotates in the first direction.

The second spring member 63 has an elongated body that has a generally rectangular shape. The body of the second spring member 63 also has a uniform thickness and width. The second spring member 63 is configured so that the second spring member 63 has a different toughness at different portions of the spring member 63 located along the length of the second spring member such that the second spring member exerts an amount of force as the portion of the second spring member winds about the fourth roller 47 that progressively increases such that the fourth roller 47 can help prevent movement of the rotatable shaft 13 to maintain a position of the window covering material after the window covering material is moved to the retracted position. The second spring member 63 is also configured to exert a progressively lesser amount of force as the portion of the second spring member winds about the third roller such that the fourth roller can prevent movement of the rotatable shaft to maintain a position of the window covering material after the window covering material is moved to the extended position.

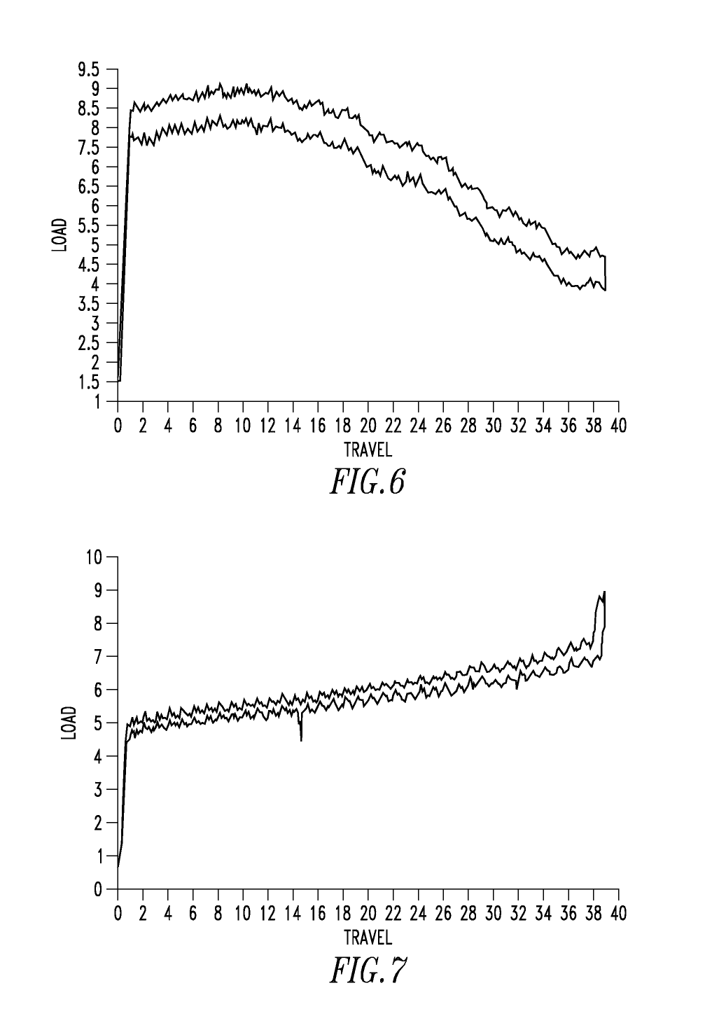

The spring members are each configured to have a varying amount of toughness at different portions located along the length of the members. As may be appreciated from FIG. 6, such varying toughness can permit the load applied by the spring members for maintaining a position of the window covering material to progressively increase when the window covering material is raised or progressively decrease when the window covering material is lowered. For instance, a spring member that was 0.003 by 0.625 by 100 inches had a load that decreased from 8.5 kg to 5.5 kg when window covering material was unwound from a retracted position to an extended position. Due to the progressively changing load applied to the spring that results from the varied toughness of the spring, the spring is able to apply a load to maintain the position of window covering material without providing too much force. Such excess force may be considered detrimental since it can cause the window covering material to be raised to a non-desired position after a user has selected the position of the window covering material.

It should be understood that shade weights and the weight of a bottom rail, if present, may affect how much of a load a spring should apply when the window covering material is raised and lowered. Additionally, friction introduced into the system by various components, such as pulleys or lift cords may also affect the load required for the spring motor to apply. Examples of forces provided by present preferred spring members used in spring motors for different weights of shade material and bottom rails to be supported by those spring members are provided below.

TABLE 1
Examples of present preferred spring member strengths for shade weights

| | | | | | |
|---|---|---|---|---|---|
| Mass To Be | 1 | 3 | 5 | 7 | 9 |
| Supported (kg) | | | | | |
| Weight to be | 9.8 | 29.4 | 49 | 68.6 | 88.2 |
| supported (N) | | | | | |
| spring force applied | 6.86 to | 20.58 to | 34.3 to | 48.02 to | 61.74 to |
| for maintaining | 12.74 | 32.34 | 63.7 | 89.18 | 114.66 |
| position of the window | | | | | |
| covering material | | | | | |
| (raised position) (N) | | | | | |
| spring force applied | 1.96 to | 5.88 to | 9.8 to | 13.72 to | 17.64 to |
| for maintaining | 5.88 | 17.64 | 29.4 | 41.16 | 52.92 |
| position of the window | | | | | |
| covering material | | | | | |
| (lowered position) (N) | | | | | |

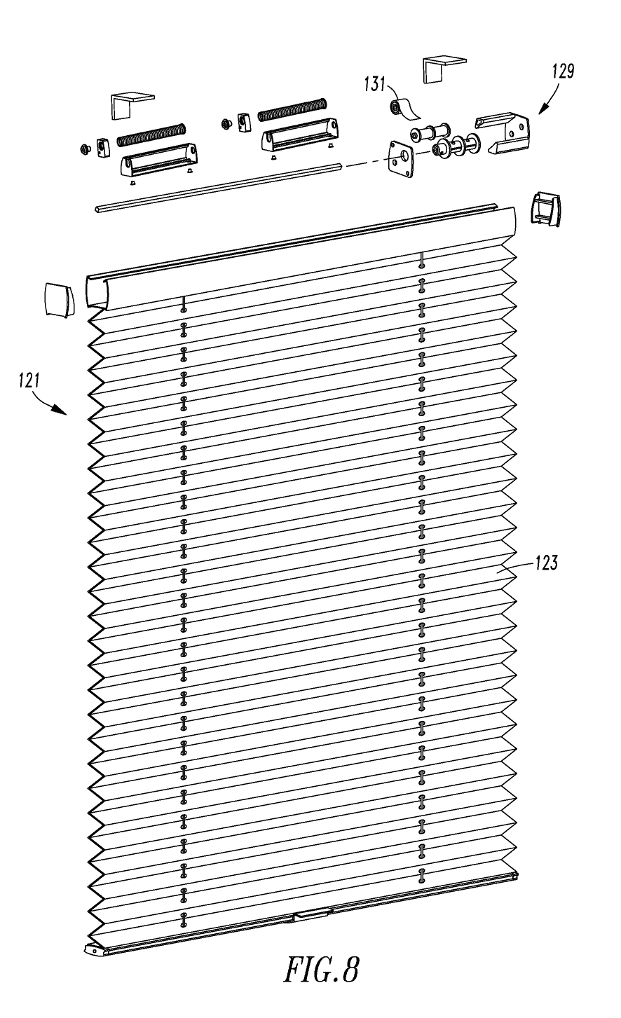

In contrast to the spring members used in embodiments of my window covering, springs typically used for cordless shades provide a constant amount of force, as may be appreciated from FIG. 7. FIG. 7 is a chart illustrating the amount of load applied by a constant force spring that is 104 inches long for when window covering material is extended. The load applied by such springs increases significantly as the shade material is extended. However, the load needed for maintaining a position of the window covering material decreases as the window covering material extends. Therefore, the increased load applied by such springs may cause the window covering material to retract or may cause the window covering material to “creep” upwards over time. Such a constant force spring often requires the use of a brake mechanism or transmission system to resolve such problems.

Embodiments of my window covering may also include a second spring motor 21. The second spring motor may include elements similar to the first spring motor 15 discussed above, as may also be appreciated from FIG. 1 and may operate and function similarly to the first spring motor 15.

It should also be appreciated that embodiments of my window covering do not require the use of transmission systems or brake mechanisms for maintaining a position of the window covering material. Embodiments of my window covering also do not require spring motors to include output and storage drums that have a special or unique geometry for spring members of the spring motors. While not being needed and not being preferred, it should be understood that brake mechanisms, transmission systems or specially shaped drums could be utilized if desired to meet a particular design objective. However, because use of the present preferred spring members discussed above permit such features to not be used, it is contemplated that most embodiments would not utilize such mechanisms since they would typically be unnecessary and only add cost to the manufacture of the window covering.

A second embodiment of my cordless window covering 121 is shown in FIG. 8. The window covering material 123 is a pleated material. That embodiment may utilize a spring 129 motor that only includes one spring member 131. It should be appreciated that the number of rollers and spring members used in each spring motor may be different for different embodiments. Some spring motors may only include one spring member while others may utilize two or more spring members. Of course, for each spring member that is used, the spring motor may also include two rollers for the winding and unwinding of that spring member.

It should be appreciated that other variations of the present preferred embodiments discussed above may be made. For example, the number of lift cords required for any particular window covering can vary according to the size and weight of the shade material. As another example, the type of material used as the window covering material may be any of a number of suitable materials. For instance, the window covering material may include a film, fabric, woven fabric, non-woven fabric, interconnected fabric segments, woven wood, woven grass, mesh material, pleated material or cellular material.

While certain present preferred embodiments of my window covering and certain embodiments of methods of practicing the same have been shown and described, it is to be distinctly understood that the invention is not limited thereto but may be otherwise variously embodied and practiced within the scope of the following claims.

1. A window covering comprising:
a first rail;
window covering material positioned adjacent to the first rail, the window covering material moveable from a retracted position to an extended position;
a rotatable shaft positioned adjacent to the first rail, the rotatable shaft having a first end and a second end opposite the first end, the rotatable shaft being rotatable in a first direction and a second direction opposite the first direction, the window covering material attached to the rotatable shaft such that the window covering material extends when the rotatable shaft rotates in the first direction and retracts when the rotatable shaft rotates in the second direction; and
a first spring motor attached to the first rail, the spring motor comprising:
a first roller, the first roller rotatable in the first direction and the second direction,
a second roller, the second roller rotatable in the first direction and the second direction, a portion of the rotatable shaft adjacent to the first end of the rotatable shaft being attached to the second roller such that rotation of the second roller in the second direction causes the rotatable shaft to rotate in the second direction and rotation of the rotatable shaft in the first direction causes the second roller to rotate in the first direction,
a first spring member extending from the first roller to the second roller, the first spring member moveable from the first roller to the second roller such that the first spring member is windable about the second roller when the second roller rotates in the second direction and the first spring member being windable about the first roller when the second roller rotates in the first direction, and
the first spring member having an elongated body that has a generally rectangular shape, the body of the first spring member also having a windable length, a uniform thickness throughout the windable length, a uniform width throughout the windable length, and a uniform rectangular cross section throughout the windable length of the first spring member, the first spring member being configured so that the first spring member has a different microstructure at different portions of the first spring member located along the windable length of the first spring member such that the first spring member exerts an amount of force as the portions of the first spring member wind about the second roller that progressively increases such that the second roller prevents movement of the rotatable shaft to maintain a position of the window covering material after the window covering material is moved to the retracted position and exerts a progressively lesser amount of force as the portions of the first spring member wind about the first roller such that the second roller prevents movement of the rotatable shaft to maintain a position of the window covering material after the window covering material is moved to the extended position.

2. The window covering of claim 1 further comprising at least one flexible elongated member extending from a position adjacent to the rotatable shaft to the window covering material to attach the window covering material to the rotatable shaft such that the window covering material extends when the rotatable shaft rotates in the first direction and retracts when the rotatable shaft rotates in the second direction.

3. The window covering of claim 2 wherein at least one flexible elongated member is at least one lift cord and the at least one lift cord is comprised of a plurality of lift cords.

4. The window covering of claim 3 further comprising a plurality of pulleys attached to the rotatable shaft, each pulley attached to a respective lift cord so that rotation of the rotatable shaft in the second direction winds the respective lift cord about that pulley and rotation of the rotatable shaft in the first direction unwinds the respective lift cord from that pulley.

5. The window covering of claim 4 further comprising a plurality of bushing members attached to the pulleys, the bushing members sized and configured to provide an interference connection between the rotatable shaft and the pulleys.

6. The window covering of claim 1 wherein the first spring member is composed of steel and wherein a strength of the first spring member varies at different portions along the windable length of the spring is formed via a heat treatment process during manufacturing of the steel of the first spring member.

7. The window covering of claim 1 wherein the first spring motor is further comprised of:
a third roller, the third roller rotatable in the first direction and the second direction,
a fourth roller, the fourth roller rotatable in the first direction and the second direction, the fourth roller attached to the second roller of the first spring motor such that rotation of the fourth roller in the second direction helps cause the rotatable shaft to rotate in the second direction and rotation of the rotatable shaft in the first direction causes the fourth roller to rotate in the first direction,
a second spring member extending from the third roller to the fourth roller, the second spring member moveable from the third roller to the fourth roller such that the second spring member is windable about the fourth roller when the fourth roller rotates in the second direction and the second spring member being windable about the third roller when the fourth roller rotates in the first direction, and
the second spring member having an elongated body that has a generally rectangular shape, the body of the second spring member also having a windable length, a uniform thickness, a uniform width and a uniform rectangular cross section throughout the windable length of the second spring member, the second spring member being configured so that the second spring member has a different microstructure at different portions of the second spring member located along the windable length of the second spring member such that the second spring member exerts an amount of force as the portions of the second spring member wind about the fourth roller that progressively increases such that the fourth roller helps prevent movement of the rotatable shaft to maintain a position of the window covering material after the window covering material is moved to the retracted position and exerts a progressively lesser amount of force as the portion of the second spring member winds about the third roller such that the fourth roller helps prevent movement of the rotatable shaft to maintain a position of the window covering material after the window covering material is moved to the extended position.

8. The window covering of claim 1 further comprising a second spring motor attached to the first rail adjacent to the second end of the rotatable shaft, the second spring motor comprising:
a first roller, the first roller rotatable in the first direction and the second direction,
a second roller, the second roller rotatable in the first direction and the second direction, a portion of the rotatable shaft adjacent to the second end of the rotatable shaft being attached to the second roller such that rotation of the second roller in the second direction causes the rotatable shaft to rotate in the second direction and rotation of the rotatable shaft in the first direction causes the second roller to rotate in the first direction,
a first spring member extending from the first roller to the second roller, the first spring member being moveable from the first roller to the second roller such that the first spring member is windable about the second roller when the second roller rotates in the third direction and the first spring member being windable about the first roller when the second roller rotates in the fourth direction, and
the first spring member having an elongated body that has a generally rectangular shape, the body of the first spring member also having a windable length, a uniform thickness along the windable length, a uniform width along the windable length and a uniform rectangular cross section along the windable length of the first spring member, the first spring member being configured so that the first spring member has a different microstructure at different portions of the spring member located along the windable length of the first spring member such that the first spring member exerts an amount of force as the portions of the first spring member wind about the second roller progressively increases such that the second roller helps prevent movement of the rotatable shaft to maintain a position of the window covering material after the window covering material is moved to the retracted position and exerts a progressively lesser amount of force as the portions of the first spring member wind about the first roller such that the second roller helps prevent movement of the rotatable shaft to maintain a position of the window covering material after the window covering material is moved to the extended position.

9. The window covering of claim 8 wherein the first spring motor is further comprised of:
a third roller, the third roller rotatable in the first direction and the second direction,
a fourth roller, the fourth roller rotatable in the first direction and the second direction, the second roller of the first spring motor attached to the fourth roller of the first spring motor such that rotation of the fourth roller in the second direction helps cause the rotatable shaft to rotate in the second direction and rotation of the rotatable shaft in the first direction causes the fourth roller to rotate in the first direction,
a second spring member extending from the third roller to the fourth roller, the second spring member moveable from the third roller to the fourth roller such that the second spring member is windable about the fourth roller when the fourth roller rotates in the second direction and the second spring member being windable about the third roller when the fourth roller rotates in the first direction, and
the second spring member having an elongated body that has a generally rectangular shape, the body of the second spring member also having a windable length, a uniform thickness along the windable length, a uniform width along the windable length, and a uniform rectangular cross section along the windable length, the second spring member being configured so that the second spring member has a different microstructure at different portions of the spring member located along the windable length of the second spring member such that the second spring member exerts an amount of force as the portions of the second spring member wind about the fourth roller that progressively increases such that the fourth roller helps prevent movement of the rotatable shaft to maintain a position of the window covering material after the window covering material is moved to the retracted position and exerts a progressively lesser amount of force as the portions of the second spring member wind about the third roller such that the fourth roller helps prevent movement of the rotatable shaft to maintain a position of the window covering material after the window covering material is moved to the extended position.

10. The window covering of claim 9 wherein the second spring motor is further comprised of:
a third roller, the third roller rotatable in the first direction and the second direction,
a fourth roller, the fourth roller rotatable in the first direction and the second direction, the second roller of the second spring motor attached to the fourth roller of the second spring motor such that rotation of the fourth roller in the second direction causes the rotatable shaft to rotate in the second direction and rotation of the rotatable shaft in the first direction causes the fourth roller to rotate in the first direction,
a second spring member extending from the third roller to the fourth roller, the second spring member moveable from the third roller to the fourth roller such that the second spring member is windable about the fourth roller when the fourth roller rotates in the second direction and the second spring member being windable about the third roller when the fourth roller rotates in the first direction, and
the second spring member having an elongated body that has a generally rectangular shape, the body of the second spring member also having a windable length, a uniform thickness along the windable length, a uniform width along the windable length and a uniform rectangular cross section along the windable length, the second spring member being configured so that the second spring member has a different toughness at different portions of the spring member located along the windable length of the second spring member such that the second spring member exerts an amount of force as the portions of the second spring member wind about the fourth roller that progressively increases such that the fourth roller helps prevent movement of the rotatable shaft to maintain a position of the window covering material after the window covering material is moved to the retracted position and exert a progressively lesser amount of force as the portions of the second spring member wind about the third roller such that the fourth roller helps prevent movement of the rotatable shaft to maintain a position of the window covering material after the window covering material is moved to the extended position.

11. The window covering of claim 1 wherein the first direction is clockwise and the second direction is counter clockwise.

12. The window covering of claim 1 wherein no transmission mechanism or gear mechanisms are utilized to convert torque provided by the first spring member of the first spring motor.

13. The window covering of claim 1 wherein the window covering is a cordless shade, the first rail is a headrail and the window covering material is comprised of one of cellular material, slats on rope ladders, pleated material, fabric material, non-woven material, woven wood material, woven grass material, bamboo, and interconnected fabric segments.

14. The window covering of claim 2 further comprising a second rail attached to at least one of the window covering material and the at least one flexible elongated member.

15. The window covering of claim 14 wherein the second rail is a bottom rail.

16. The window covering of claim 1 wherein the rotatable shaft has a cross section that has a polygonal shape.

17. The window covering of claim 1 wherein the rotatable shaft is a bar or rod.

18. The window covering of claim 1 further comprising at least one bushing within the opening of the second roller of the first spring motor, the at least one bushing sized and configured such that the portion of the rotatable shaft adjacent to the first end of the rotatable shaft within the opening of the second roller of the first spring motor has an interference attachment to the second roller of the first spring motor.

19. The window covering of claim 1 wherein the first spring member of the first spring motor is comprised of an elongated body having a plurality of integrally attached portions, the portions comprising a first portion, a second portion and a third portion, the first portion of the body being adjacent to a first end of the body and the third portion of the body being adjacent to a second end of the body, the second end of the body being opposite the first end of the body, the second portion of the body being between the first and third portions of the body, the first portion, second portion and third portion of the body each having a different microstructure and a different strength.

20. The window covering of claim 1 wherein the second roller of the first spring motor has an opening sized and configured to receive a portion of the rotatable shaft adjacent to the first end of the rotatable shaft and that portion of the rotatable shaft is positioned within the opening of the second roller to attach the rotatable shaft to the second roller of the first spring motor.
